(19) United States
(12) Patent Application Publication
(10) Pub. No.: US 2010/0176163 A1
(43) Pub. Date: Jul. 15, 2010

(54) Nozzle brick with a seal

(75) Inventors: Erkki Helanto, Kirkkonummi (FI); Mikael Silfvenius, Tammisaari (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Indref Oy

(21) Appl. No.: 12/657,295

(22) Filed: Jan. 15, 2010

(30) Foreign Application Priority Data
Jan. 15, 2009 (FI) 20095030

(51) Int. Cl. B22D 41/50; F16J 15/02

(52) U.S. Cl. 222/591; 277/312

(57) ABSTRACT

The invention relates to the sealing between the bottom nozzle brick (1) and shroud (5). The sealing has been made into an area on the outer surface of the bottom nozzle brick (1) and a place or formations (10) have been provided for improving the grip of the seal (3) and for holding the seal (3) in place.

### CROSS REFERENCE TO RELATED APPLICATION

This application claims priority under 35 USC §119(e) to Finnish Patent Application No. 20095030 filed on Jan. 15, 2009.

### TECHNICAL FIELD

The invention relates to the manufacture of molten steel. More particularly it concerns the bottom brick for the closing mechanism of a tundish, which is sealed fast to a shroud.

### BACKGROUND OF THE INVENTION

In state-of-the-art solutions, a long conical seal is inserted between a bottom nozzle brick with a conical lower section and a shroud, the seal being often manufactured of aluminium oxide. Sealing is achieved as the steel pouring ladle stands on top of the casting machine, and its purpose is to prevent impurities in the air, especially nitrogen, from entering the molten steel during casting. If the sealing has been done well, purer and better-quality steel will be obtained from the process. Long and conical “sleeve-type” seals to be inserted on top of a bottom nozzle brick are disclosed e.g. in the publications DE 44 20 199 A1 and JP 60199556.

A sealing solution of another type is disclosed in the publication U.S. Pat. No. 4,949,885, in which sealing has been achieved by a planar sealing ring between two front faces. In this case the seal is inserted onto the front face of a shroud before the bottom nozzle brick and shroud are joined together.

In the state-of-the-art solutions mentioned above, the insertion of the seal is very dangerous, because upon inserting the seal the worker has to go under a pouring ladle, which is full of molten steel.

### SUMMARY OF THE INVENTION

The purpose of the invention is to eliminate the state-of-the-art drawbacks in the insertion of the sealing and to achieve a seal, which can be safely inserted to the bottom nozzle brick and which need not be inserted in place under a full pouring ladle.

This will be achieved by providing a place for the seal in the bottom nozzle brick and by preparing one uniform entity of the bottom nozzle brick and seal. As the seal is already inserted in the bottom nozzle brick, no separate seal will be needed and the worker does not have to enter dangerous conditions under the pouring ladle.

More particularly the invention is characterised in what is shown in the characterising part of the independent claims. The dependent claims further disclose other advantageous embodiments of the invention.

### BRIEF DESCRIPTION OF THE DRAWINGS

The invention will next be explained in more detail by referring to the enclosed drawings, in which

FIG. 1 illustrates an embodiment of the sealing of the bottom nozzle brick and shroud;

FIG. 2 illustrates a second embodiment of the sealing of the bottom nozzle brick and shroud; and

FIG. 3 illustrates an embodiment, in which grips are provided in the bottom nozzle brick for the seal.

### DETAILED DESCRIPTION

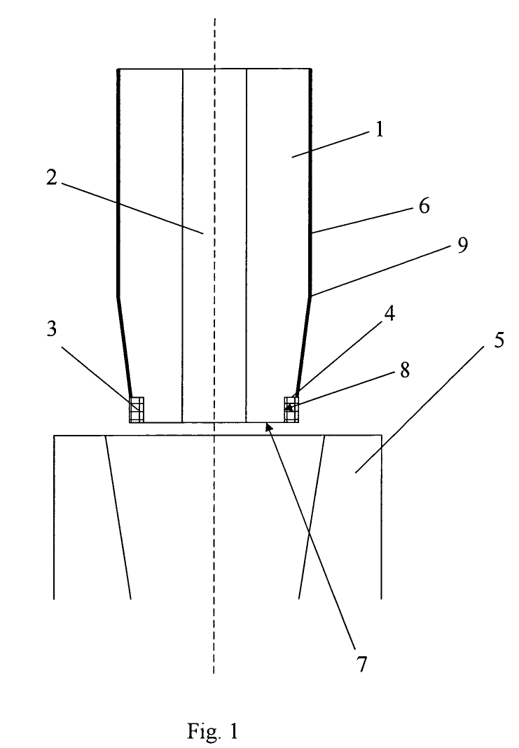

In FIG. 1 there is shown a bottom nozzle brick 1 with a flow aperture 2 for molten metal. The bottom nozzle brick 1 is provided with an insertion groove 4 for an annular seal 3. The seal 3 is inserted into the insertion groove 4 of the bottom nozzle brick 1 before the bottom nozzle brick is brought below the pouring ladle. Sealing with the shroud 5 occurs automatically due to the conical structure of the bottom nozzle brick 1 and shroud as the pieces are brought into nested position. The structure of the bottom nozzle brick 1 comprises the actual brick with the flow aperture 2 for the cast and the metal jacket 6 on the outer surface of the brick. In the solution according to FIG. 1, the metal jacket 6 does not extend to the lower edge 7 of the bottom nozzle brick 1, but it ends at the insertion point 4 for the seal 3. In this case the seal 3 will be inserted directly onto the brick surface 8. This surface 8 is coarser than the metal surface so that it facilitates the seal 3 to be held in place. However, the metal jacket 6 can be formed to also cover the insertion point 4 for the seal 3 so that the metal jacket extends to the lower edge 7 of the bottom nozzle brick 1. Compared with state-of-the-art sleeve-type solutions, the insertion point for the seal 3 is different. The state-of-the-art sleeve-type seal should be inserted all the way from the lower edge 7 of the bottom nozzle brick 1 to the bending point 9 in the bottom nozzle brick, i.e. it would essentially cover the entire conical part of the bottom nozzle brick. In addition, in state-of-the-art solutions, the steel jacket 6 extends all the way to the lower edge 7 of the bottom nozzle brick 1 and the seal is inserted on top of the steel surface.

In the solution of the embodiment shown in FIG. 1, the seal 3 excellently protects the edge of the metal jacket 6 of the bottom nozzle brick 1 from metal splatters during casting. This problem caused by the splattering of molten metal is typical in state-of-the-art solutions.

The bottom nozzle brick 1 is generally used approximately 3-4 times before it is replaced, and the seal 3 of the bottom nozzle brick is changed after each use. The manufacturing material for the seal 3 is typically graphite so that it would withstand the high heat at the insertion point. The cross-sectional shape of the seal 3 can be selected very freely. Applicable cross-sectional shapes are e.g. a rectangle, square, circle, ellipse, triangle, or quadrangle.

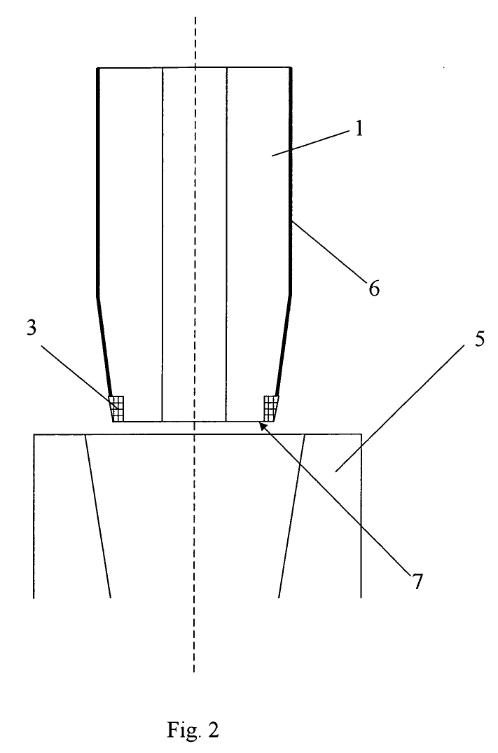

In FIG. 2 there is illustrated a quadratic cross-sectional shape for the seal solution according to the invention. Here a quadratic sealing ring is installed to the insertion point of the seal 3 of the bottom nozzle brick 1. Such a bevelled sealing ring conforming to the inner surface of the shroud 5 provides a better sealing than a sealing ring with a rectangular or square cross-section. Also this solution can be realised so that the metal jacket 6 extends to the lower edge 7 of the bottom nozzle brick 1.

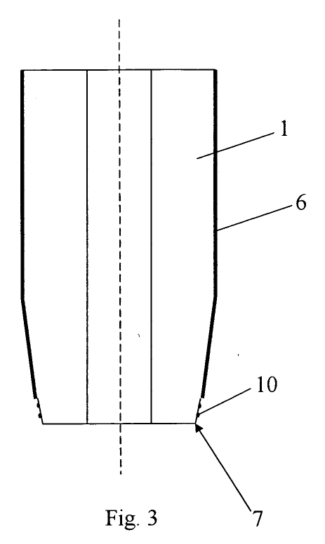

In FIG. 3 there is shown a second embodiment of the solution of the invention. Here the area of the bottom nozzle brick 1 that is not coated with metal is provided with grips 10 for attaching the seal (not shown in the Figure). Such grips 10 can be of many different shapes. It is essential that they keep the seal in place as the bottom nozzle brick 1 is installed under the pouring ladle. In this embodiment the seal preferably has a rectangular cross-section, but it is obvious that the cross-sectional shape of the seal used can vary.

The grips 10 generated to the bottom nozzle brick 1 can circulate (extend) around the bottom nozzle brick as uniform rings or they can comprise only a part of the circumference of the bottom nozzle brick. The number of grips 10 can also vary in the direction of the longitudinal axis of the bottom nozzle brick 1 according to the requirements set by the seal's shape and size. Also this solution can be realised so that the metal surface 6 of the bottom nozzle brick 1 extends to the lower edge 7 of the bottom nozzle brick. In this case the grips 10 are prepared directly to the metal jacket 6 of the bottom nozzle brick 1.

The installation of the seal 3 is thus performed directly onto the brick surface 8 or directly onto the metal jacket 6 covering the seal's insertion point. The metal surface layer 6 of the bottom nozzle brick 1 has been removed or it has not been manufactured into the future sealing area, or it has been formed to also cover the insertion point of the seal 3. The metal jacket 6 can also be manufactured either entirely or only partly under the seal 3.

Aluminium oxide, graphite or some other material resistant to the heat of steel casting can be used as the material for the seal 3.

The method for sealing the contact between the bottom nozzle brick 1 and shroud 5 comprises the following steps:
arranging at least partly the bottom nozzle brick 1 with a metal jacket, the side of the lower part of which contains a formed area essentially on a range corresponding to the height of the seal 3 to be used, the area comprising a cylindrical recess for installing the seal 3 into the area or grips 10 for installing the seal;
installing the seal 3 to the bottom nozzle brick 1;
installing the bottom nozzle brick 1 with its seal 3 under the pouring ladle; and
bringing the bottom nozzle brick 1 into sealed contact with the shroud 5.

In addition, the method can comprise a step, in which
the bottom nozzle brick (1) is arranged without the metal jacket (6) in the area of the seal (3);
   or the method can further comprise a step, in which
the bottom nozzle brick (1) is arranged, with the metal jacket (6) extending at least partly into the area of the seal (3).

Various embodiments of the invention have been illustrated above by means of examples. They are by no means restricting, and the protective scope of the invention is defined in accordance with the protective scope defined by the enclosed patent claims.

What is claimed is:

1. A bottom nozzle brick comprising at least partly an outer jacket of metal and a flow aperture for molten metal, a lower part of the brick being formed conical for at least part of the way; wherein the lower part of the bottom nozzle brick, its outer surface, is provided with an area formed for an annular seal.

2. The bottom nozzle brick according to claim 1, wherein the area for the seal is a cylindrical recess built to the conical lower part of the bottom nozzle brick.

3. The bottom nozzle brick according to claim 2, wherein the cylindrical recess extends from a lower end of the bottom nozzle brick upwards essentially in a range corresponding to a height of the seal.

4. The bottom nozzle brick according to claim 1, wherein the area for the seal contains grips for the seal.

5. The bottom nozzle brick according to claim 4, wherein the grips are at least partly protrusions encircling the bottom nozzle brick.

6. The bottom nozzle brick according to claim 1, wherein the metal jacket does not extend under the seal.

7. The bottom nozzle brick according to claim 1, wherein the metal jacket extends at least partly under the seal.

8. The bottom nozzle brick according to claim 1, wherein the cross-section of the ring seal is essentially a rectangle, square, circle, ellipse, triangle, or quadrangle.

9. The bottom nozzle brick according to claim 1, wherein the seal is made of aluminium oxide, graphite or some other heat-resistant material.

10. A method for sealing the contact between a bottom nozzle brick and a shroud, comprising:
arranging the bottom nozzle brick with at least a partly metal surface, on a side of a lower part of which there is an area substantially on a range corresponding to a height of a seal to be used and that the area comprises a cylindrical recess for installing the seal into the area or grips for installing the seal;
installing the seal to the bottom nozzle brick;
installing the bottom nozzle brick with its seal under the pouring ladle; and
bringing the bottom nozzle brick into sealed contact with the shroud.

11. The method according to claim 10, further comprising:
arranging the bottom nozzle brick without the metal jacket in the area of the seal.

12. The method according to claim 10, further comprising:
arranging the bottom nozzle brick so that the metal jacket extends at least partly into the area of the seal.
